(19) United States
(12) Patent Application Publication
(10) Pub. No.: US 2021/0016995 A1
(43) Pub. Date: Jan. 21, 2021

(54) MONITORING CONDITION OF A ROPE

(71) Applicant: BRIDON INTERNATIONAL LIMITED, South Yorkshire (GB)

(72) Inventors: Timothy HUNTER, Glasgow (GB); Pengzhu WANG, Doncaster (GB); Xavier AMILS, Kortrijk (BE)

(73) Assignee: BRIDON INTERNATIONAL LIMITED, South Yorkshire (GB)

(21) Appl. No.: 17/040,679

(22) PCT Filed: Apr. 3, 2019
(86) PCT No.: PCT/EP2019/058349

§ 371 Date: Sep. 23, 2020

(30) Foreign Application Priority Data
Apr. 18, 2018 (EP) 18250012.4

(51) Int. Cl. B66B 7/12

(52) U.S. Cl. CPC B66B 7/1238

(57) ABSTRACT

The condition of a rope (20) is monitored according to the following steps: 1) providing a rope (20) with plastic material (22) inside the rope (20) and strength members (24, 28) present at least at the radially outer surface of the rope (20); 2) monitoring the rope (20) during its lifetime until parts of the plastic material (25) move to the radially outer surface until they become detectable at the outer surface of the rope (20).

### TECHNICAL FIELD

The invention relates to a method of monitoring the condition of a rope.

### BACKGROUND ART

Ropes are much used on winches and cranes and other pulling and hoisting devices e.g. land based cranes, abandonment and recovery (A&R), knuckle boom crane, riser pull in, riser tensioners, drag shovel hoist, anchor lines, deep shaft hoisting drum and friction winding applications and elevators. In these applications, the ropes need to be replaced before their end of life, since a fracture of the complete rope may cause serious human and material damage.

Hence, ropes are regularly inspected as to the presence of broken wires, corrosion, to changes in diameter, changes in lay length, waviness etc. . . . . These existing methods have limited reliability and are difficult to apply to fibre ropes.

Prior art documents WO 2017/068054 A1 and WO 2017/067651 A1 disclose a synthetic rope and a method of monitoring the condition of a synthetic rope. The load bearing part of this synthetic rope is surrounded by a wear-indicating sheath. The wear-indicating sheath comprises polymer fibres of different resistance to abrasive wear and/or tensile strength and/or resistance to reverse bending stress.

WO 2010/041002 discloses a fibruous assembly with two components. The first component provides a visual indication of when a predetermined tensile load is applied to the assembly or when the fibres have been over-extended. Typically the fibruous assembly comprises auxetic yarns. The auxetic yarns comprise a polyurethane core that is surrounded/wrapped by a high modulus polymer component, such as DYNEEMA® or SPECTRA® or KEVLAR®. The choice of the wrap angle together with the choice of the particular auxetic yarn and its diameter affect the performance and mode of visual indication of the fibruous assembly.

WO 93/03219 discloses a rope including a heat sensitive component which is subject to a visible change in appearance, such as a colour change, when exposed to a selected elevated temperature resulting from a strain-related heat release from the rope.

EP 2 894 119 A1 discloses an elevator rope comprising at least one load bearing member. The load bearing member is made of a composite material with reinforcing fibres in a polymer matrix.

The matrix comprises capsules storing monomer substance in fluid form. The capsules may become ruptured as a result of rupture in the load bearing material. Since the substance in the capsules is fluid, it will easily spread and indicate a need for repairment.

US 2007/0125060 A1 discloses a method of determining the wear and characteristics of twisted rope lines used in rigging systems.

One or more differently colored yarns are added to at least one of the strands of the twisted rope.

They are originally positioned as not to be visible to the naked eye. During life time, frictional forces, fraying of the outermost yarns, will eventually expose the colored yarns to the surface, providing a visual indicator.

### DISCLOSURE OF INVENTION

It is a general object of the present invention to provide an alternative way of monitoring the life time or condition of a rope.

It is another object of the present invention to provide a way of monitoring life time or condition of a rope that is suitable for a synthetic rope, a steel rope and a hybrid (synthetic-steel) rope.

According to the present invention, there is provided a method of monitoring the condition of a rope. The rope comprises twisted or braided load-bearing members.

The method comprises the following steps:

1) providing a rope with non-load bearing solid plastic material inside the rope and strength members twisted or braided at least at the radially outer surface of the rope;

2) monitoring the rope during its lifetime until parts of the plastic material move to the radially outer surface so that the parts become detectable at the outer surface of the rope.

The advantage of this monitoring method is that it is a simple method and that use can be made of plastic material that is already inside quite a lot of ropes for other purposes. Furthermore, the monitoring method is useful not only as monitoring tool but also to increase resistance against fretting of various fibres or wires or strands inside the rope in case plastic material is added to ropes where no plastic material was present before. In addition, the addition of plastic material improves the radial stability.

The terms ‘solid plastic material’ refer to plastic material that is not liquid in an unsolicited state at temperatures below 30° C. The terms ‘non-load bearing plastic material’ refer to plastic material that has a tensile strength that is lower than 5% of the tensile strength of the load bearing members, e.g. lower than 2%.

Another advantage is that this monitoring method is suitable for synthetic ropes, steel wire ropes and hybrid ropes, where the term ‘hybrid’ refers to ropes with load bearing members of both steel and synthetic material.

The terms ‘until the parts become detectable at the outer surface of the rope’ refer to a situation where plastic material becomes detectable at the outer surface of the rope, i.e. protruding out of the virtual cylinder surrounding the rope.

Once a significant amount of the plastic material becomes detectable at the outer surface of the rope, the rope can be the subject of a further detailed inspection or one can replace the rope or one can decide to wait until a further phase of wear progress.

The plastic material is preferably a thermoplastic polymer that has no load-bearing function. During the lifetime of the rope, this plastic material fulfils another function than bearing load. The plastic material may function as a anti-fretting cushion positioning various load bearing steel strands or synthetic strands so that they do not abrade against each other. The plastic material may also function as corrosion protection for load bearing steel elements inside the plastic material.

The plastic material is preferably so selected that its wear rate is greater than the wear rate of the load bearing elements in the rope. So the appearance of parts of the plastic material at the outer surface of the rope happens before substantial loss of breaking load or fatigue resistance.

According to the invention, the monitoring may be done visually by human eyes or may be done mechanically or optically by a detection apparatus. During mechanical monitoring a local increase in rope diameter is detected. During optical monitoring, the appearance of a significant amount of plastic material at the outer surface of the rope is being watched.

The exact size of the diameter increase or the amount or volume of plastic material that is needed to trigger a first signal or alarm depends upon the particular rope, the type, amount and position of plastic material and the criticality of the use of the rope and need to be determined case by case.

The load bearing members in the rope may be steel wires, synthetic fibres, synthetic tapes, synthetic rods or a combination thereof.

The plastic material inside the rope may be a homopolymer, a copolymer, a thermoplastic plastomer, an elastomer, a thermoplastic elastomer, or a combination thereof.

The plastic material may be present in various forms: e.g. as extruded material, e.g. in the form of an extruded core, in filament form, in film form, etc. . . . .

The plastic material may be applied by extrusion, e.g. extrusion around a core, braiding, stranding, winding, etc. . . . .

Preferably the plastic material may have a colour that is different from the colour of the load bearing members at the radially outer surface of the rope.

Viewed from an alternative and independent aspect of the invention, there is provided a method of monitoring the condition of a rope. The method comprises following steps:

a) providing a core comprising non-load bearing thermoplastic polymer;

b) twisting, braiding or wrapping load bearing members around the core so as to form a rope;

c) putting the rope in service;

d) monitoring the rope during its lifetime until parts of the polymer move to the radially outer surface so that the parts become detectable at the outer surface of the rope.

The non-load bearing thermoplastic polymer may be provided by means of extrusion. The core may consist of extruded thermoplastic polymer or, alternatively, may comprise one or more load bearing members where thermoplastic material has been extruded around.

The core may have a circular cross-section or, alternatively, a non-circular cross-section, e.g. a fluted core with grooves to locate the various surrounding load bearing members.

A rope with a core comprising non-load bearing thermoplastic polymer and load bearing members around is known as such. However, up to now, the non-load bearing thermoplastic polymer has not yet been used as a monitoring tool. In comparison with existing ropes, the non-load bearing thermoplastic has a higher wear rate, a lower melting point, a lower viscosity.

The method of monitoring as described above for the entire rope, i.e. with a core having a non-load bearing thermoplastic polymer and strength members around may be applied also for one or more strands in case of a multi-strand rope. This means that one or more strands will have a core with non-load bearing thermoplastic material and strength members around. During service or life time, the related strands are monitored until the thermoplastic polymer appears at the surface of the strand.

In an alternative and preferable embodiment of the invention, different types of plastic material may be present inside the rope.

Preferably, the different types of plastic material may move at different rates to the outer surface of the rope so that one type of plastic material becomes sooner detectable than another type of plastic material.

The different types of plastic material may be present at different locations inside the rope, e.g. one type of plastic material may be present just under the radially outer layer of load bearing members, another type of plastic material may be present close to the core of the rope.

Most preferably, the plastic material which moves at a higher rate is present radially externally to plastic material which moves at a lower rate. The plastic material which moves at a higher rate may have either a lower viscosity or have a higher wear rate or both than the plastic material which moves at a lower rate.

The different types of plastic material may have a different colour.

The rope may be a single strand rope or a multi-strand rope. The rope may be a braided or a stranded construction.

In case of a multi-layer rope, plastic material is present inside at least one of the radially outer strands.

### BRIEF DESCRIPTION OF FIGURES IN THE DRAWINGS

FIG. 1 shows a cross-section of a first rope before putting in use;

FIG. 2 shows a cross-section of a first rope after some use;

FIG. 3 shows a cross-section of a second rope after some use.

### MODE(S) FOR CARRYING OUT THE INVENTION

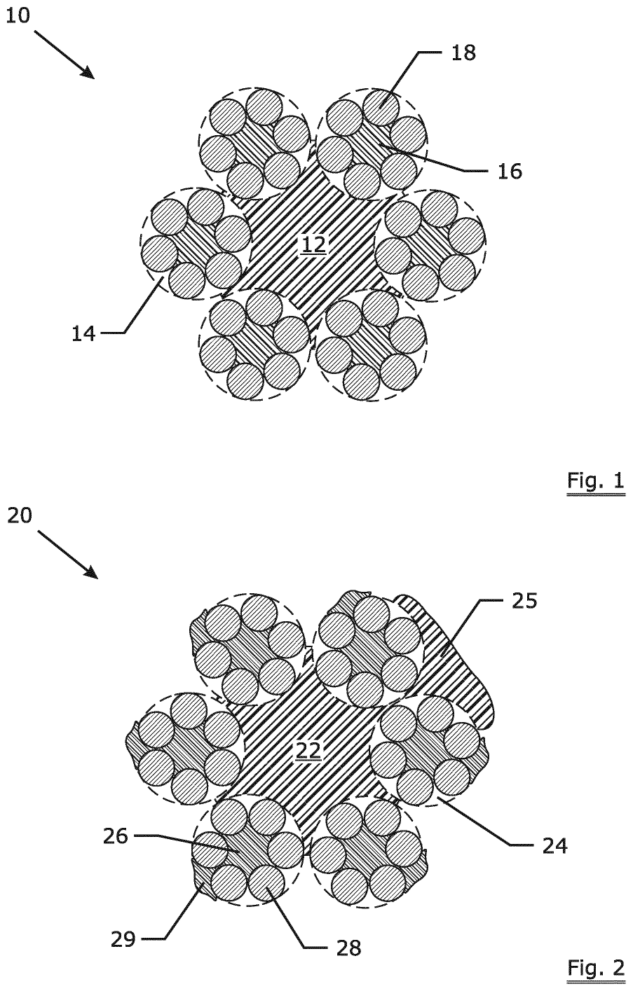

FIG. 1 is a schematic presentation of a cross-section of a steel wire rope 10 before this rope is subjected to loading. The rope 10 comprises a plastic core 12 and a layer of steel strands 14 surrounding the plastic rope core 12. Each of the steel strands 14 comprises a plastic strand core 16 and several steel wires 18 surrounding the plastic strand core 16.

Still referring to FIG. 1, there may be small openings or interstices between the various steel strands 14, but this does not mean that plastic material becomes ‘detectable’ or physically present at the outer surface of the rope in the meaning of the present invention. The same is valid for any openings or interstices between the various steel wires 18 of the strands 14.

FIG. 2 is a schematic presentation of cross-section of a steel wire rope 20, similar to steel wire rope 10, however, after being put in practice and after having been subjected to loading or bending or both so that plastic material becomes detectable at the outer surface of the rope 20.

The rope 20 comprises a plastic rope core 22 and strands 24 surrounding the plastic rope core 22. During use of the rope 20, the plastic rope core 22 has started moving and flowing until a part 25 protrudes from the rope and becomes detectable at the outer surface of the rope 20.

At least one steel strand 24 comprises a plastic strand core 26 and steel wires 28 twisted around the plastic strand core 26.

In addition to the protruding part 25 or alternatively to the protruding part 25, plastic may have moved or flowed so that a part 29 protrudes from strand 24 and becomes detectable at the outer surface of the rope 20.

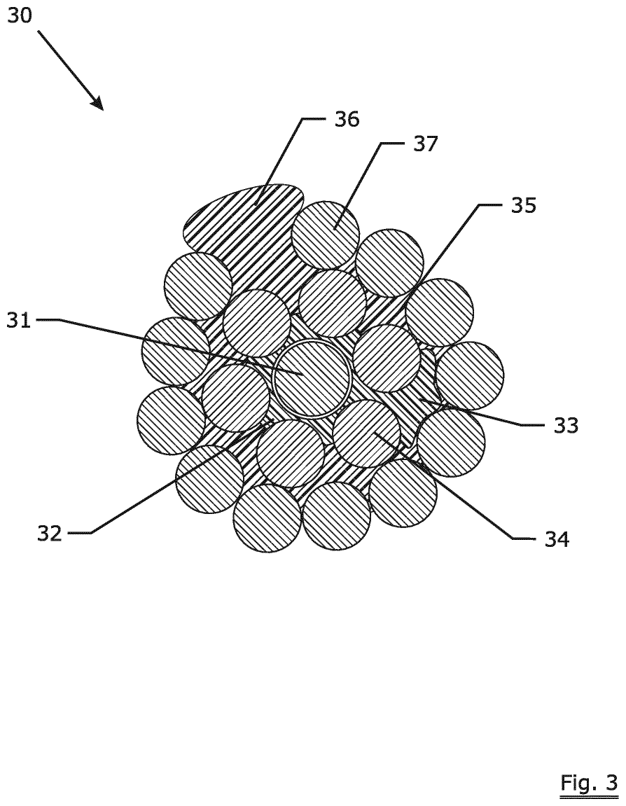

FIG. 3 is a schematic presentation of a cross-section of another rope 30 after having been subjected to loading or bending or both.

Rope 30 comprises a core steel wire 31 extruded with an inner plastic layer 32 that started to move radially externally to form a part 33 that protrudes outside the intermediate layer of steel wires 34. The rope 30 further comprises an outer plastic layer 35 that was extruded around the intermediate layer of steel wires 34 and moved to the outer surface of the rope 30 and formed a part 36 protruding outside the outer layer of steel filaments 37.

Preferably the plastic material 35 has a lower viscosity or higher wear rate than the plastic material 32 so that is starts to move or flow earlier.

Preferably the plastic material 35 has another colour than the plastic material 32.

In case one decides that the rope 30 can still function properly despite appearance of plastic parts 36 at the outer surface, one may wait until plastic material 32, 34 becomes detectable at the outer surface. In this way the appearance of plastic parts 36 only serves as a first stage warning.

The above examples all relate to steel wire ropes. However, the invention is also applicable to synthetic ropes or to hybrid ropes, where synthetic fibres function as load bearing members.

Synthetic Fibre

In case synthetic fibres are present in the rope as load bearing members, the invention is not limited to certain types of synthetic fibres but is applicable for all types of synthetic fibres. Examples of fibres are polyamide fibres, polyester fibres, polyolefin fibres such as polypropylene and polyethylene fibres, and particularly high strength synthetic fibres such as high strength polypropylene (HSSP), high modulus polyethylene (HMPE), ultra high molecular weight polyethylene (UHMwPE), para-aramid fibres such as poly(P-phenylene terephthalamide) (PPTA) fibres, liquid crystal polyester (LCP/LCAP), poly(P-phenylene-2,6-benzobisoxazole) (PBO), meta-aramid fibres such as poly (m-phenylene isophthalamide fibres, copolyamide fibres of (terephthaloyl chloride, P-phenylenediamine, 3,4′-diaminodiphenyl ether), normally referred to as “copolymer aramid”).

The polymer materials may be present not only in fibre format but also in other longitudinal format such as a tape, filament and rods.

Various different fibres may also be combined in one strand and/or in one rope.

Steel Wire

In case of steel wires, the wires of the rope may be made of high-carbon steel. A high-carbon steel has a steel composition as follows: a carbon content ranging from 0.5% to 1.15%, a manganese content ranging from 0.10% to 1.10%, a silicon content ranging from 0.10% to 1.30%, sulfur and phosphorous contents being limited to 0.15%, preferably to 0.10% or even lower; additional micro-alloying elements such as chromium (up to 0.20%-0.40%), copper (up to 0.20%) and vanadium (up to 0.30%) may be added. All percentages are percentages by weight.

Preferably, the steel wires and/or steel wire strands of at least one metallic layer are coated individually with zinc and/or zinc alloy. More preferably, the coating is formed on the surface of the steel wire by galvanizing process. A zinc aluminum coating has a better overall corrosion resistance than zinc. In contrast with zinc, the zinc aluminum coating is more temperature resistant. Still in contrast with zinc, there is no flaking with the zinc aluminum alloy when exposed to high temperatures. A zinc aluminum coating may have an aluminum content ranging from 2 wt % to 12 wt %, e.g. ranging from 5% to 10%. A preferable composition lies around the eutectoid position: aluminum about 5 wt %. The zinc alloy coating may further have a wetting agent such as lanthanum or cerium in an amount less than 0.1 wt % of the zinc alloy. The remainder of the coating is zinc and unavoidable impurities. Another preferable composition contains about 10% aluminum. This increased amount of aluminum provides a better corrosion protection than the eutectoid composition with about 5 wt % of aluminum. Other elements such as silicon and magnesium may be added to the zinc aluminum coating. More preferably, with a view to optimizing the corrosion resistance, a particular good alloy comprises 2% to 10% aluminum and 0.2% to 3.0% magnesium, the remainder being zinc.

Preferably, the steel wires and/or steel wire strands are end galvanized. In other words, there is no further drawing carried out for the coated wires or wire stands. Thus, a higher coating weight and a better corrosion resistance are obtained together with a high yield strength.

### LIST OF REFERENCE NUMBERS

10 rope with polymer material inside before use
12 plastic core of rope
14 layer strand
16 plastic core of strand
18 steel wire of strand
20 rope with plastic material inside after some use
22 plastic core of rope
24 strand
25 protruding part of plastic core of rope
26 plastic core of strand
28 steel wire of strand
29 protruding part of plastic core of strand
30 rope with two types of plastic material inside after some use
31 core steel wire
32 inner plastic around core steel wire
33 protruding part of inner plastic
34 steel wire of intermediate layer
35 outer plastic around intermediate layer
36 protruding part of outer plastic
37 steel wire of outer layer

1. A method of monitoring the condition of a rope comprising load bearing members that are twisted or braided together,
said method comprising the following steps:
providing a rope with non-load bearing solid plastic material inside said rope and strength members twisted or braided at least at the radially outer surface of the rope;
monitoring the rope during its lifetime until parts of said plastic material move to the radially outer surface until said parts become detectable at the outer surface of the rope.

2. The method according to claim 1,
wherein said monitoring is done visually by human eyes.

3. The method according to claim 1,
wherein said monitoring is done optically by a measuring device.

4. The method according to claim 1,
wherein said monitoring is done mechanically by a measuring device.

5. The method according to claim 1, wherein said load bearing members are steel wires, synthetic fibres, synthetic tapes, synthetic rods, or a combination thereof.

6. The method according to claim 1, wherein said plastic material is a homopolymer, a copolymer, a thermoplastic plastomer, an elastomer, a thermoplastic elastomer, or a combination thereof.

7. The method according to claim 1, wherein said plastic material has a colour different from the colour of said load bearing members.

8. The method according to claim 1, wherein different types of said plastic material are present inside said rope.

9. The method according to claim 8,
wherein said different types of said plastic material have different viscosities or different wear rates.

10. The method according to claim 9,
wherein said different types of said plastic material are present at different locations inside said rope.

11. The method according to claim 9, wherein plastic material with a lower viscosity or with a higher wear rate is present radially externally to plastic material with a higher viscosity.

12. The method according to claim 1, wherein said rope is a multi-strand rope and wherein said plastic material is present inside at least one of the radially outer strands.
